(19) United States
(12) Patent Application Publication
(10) Pub. No.: US 2022/0413360 A1
(43) Pub. Date: Dec. 29, 2022

(54) BLADE DRIVING DEVICE, CAMERA DEVICE AND ELECTRONIC APPARATUS

(71) Applicant: New Shicoh Motor Co., Ltd., Zhejiang (CN)

(72) Inventor: Xuepeng FU, Yamato City (JP)

(21) Appl. No.: 17/846,515

(22) Filed: Jun. 22, 2022

(30) Foreign Application Priority Data
Jun. 23, 2021 (CN) 202110701506.5

(51) Int. Cl. G03B 9/06; H04N 5/225

(52) U.S. Cl. CPC G03B 9/06; H04N 5/2253

(57) ABSTRACT

A blade driving device in which a central axis is defined includes a blade, a base, a movable ring, driving mechanism and a plurality of plate springs. The base is formed in an annular shape centered on the central axis. The movable ring is formed in an annular shape centered on the central axis. The driving mechanism drives the blade by rotating the movable ring around the central axis with respect to the base. The plate springs connect the base and the movable ring to rotatably support the movable ring with respect to the base. The plate springs are arranged at equal intervals around the central axis and expand in a radial direction of a circle centered on the central axis and in a central axis direction.

### CROSS-REFERENCE TO RELATED APPLICATIONS

This application claims the benefit of Chinese Patent Application No. 202110701506.5 filed on Jun. 23, 2021, which is hereby incorporated by reference herein in its entirety.

### TECHNICAL FIELD

The present disclosure relates to a blade driving device used in electronic apparatus such as smartphones, a camera device and an electronic apparatus.

### BACKGROUND

Various techniques have been proposed to adjust the amount of light in the lens body by sliding the blades of the camera device. The camera module disclosed in Chinese Patent Publication No. 110858048A (hereinafter referred to as “Patent Document 1”) has three blades arranged around the incident hole, and these three blades are driven to change the amount of light incident on the lens body. In this camera module, three driving coils are arranged on the FPC (Flexible Printed Circuits) on the bottom surface of the housing that holds the blades and three driving magnets are arranged on the movable ring facing the housing, respectively, and the movable ring is rotated about the optical axis by the electromagnetic force generated by the driving coils and the driving magnets to move the blades. The diaphragm mechanism device disclosed in Korean Patent Publication No. 2018-0105970A (hereinafter referred to as “Patent Document 2”) has two substantially L-shaped blades called blades facing each other around the incident hole, and these two blades are driven to change the amount of light incident on the lens body. In this diaphragm mechanism device, three coils are arranged on the FPC on the bottom surface of the base and three permanent magnets are arranged on the rotation ring on the upper side of the base, respectively, and the rotation ring is rotated about the optical axis by the electromagnetic force generated by the coils and the permanent magnets to move the blades.

However, in the techniques described in Patent Documents 1 and 2, there was a problem that the blades move freely when the application of voltage to the coils is stopped and the driving force is not applied.

### SUMMARY

The present disclosure has been made in view of such a problem, and one of the objects is to provide a blade driving device in which the blades do not move freely even when no driving force is applied to the blades.

In accordance with a first aspect of the present disclosure, there is provided a blade driving device in which a central axis is defined, including: a blade; a base formed in an annular shape centered on the central axis; a movable ring formed in an annular shape centered on the central axis; a driving mechanism that drives the blade by rotating the movable ring around the central axis with respect to the base; and a plurality of plate springs that connect the base and the movable ring to rotatably support the movable ring with respect to the base, wherein the plurality of plate springs are provided at equal intervals around the central axis and expand in the radial direction of a circle centered on the central axis and in the central axis direction.

In accordance with a second aspect of the present disclosure, there is provided a camera device including the blade driving device described above.

In accordance with a third aspect of the present disclosure, there is provided an electronic apparatus including the camera device described above.

Further features of the present invention will become apparent from the following description of exemplary embodiments with reference to the attached drawings.

### BRIEF DESCRIPTION OF DRAWINGS

FIG. 1 is a front view of a smartphone on which a camera device is mounted, the camera device including a blade driving device according to a first embodiment of the present disclosure;

FIG. 2 is a perspective view of the blade driving device of FIG. 1;

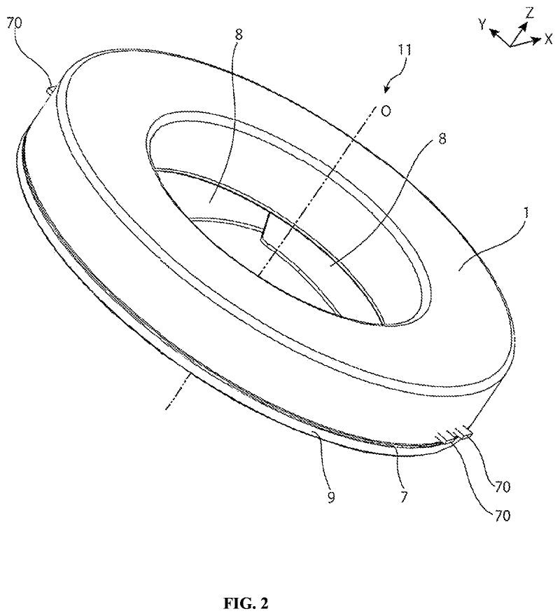

FIG. 3 is an exploded perspective view of the blade driving device of FIG. 2;

FIG. 4 is a diagram in which the cover is removed from FIG. 2;

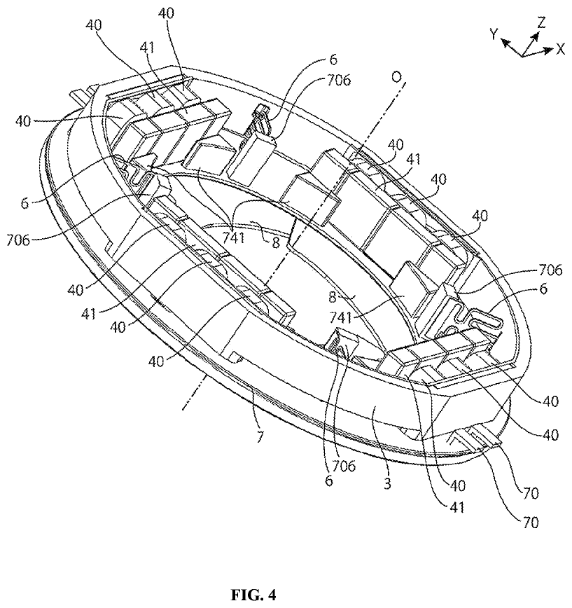

FIG. 5 is a diagram showing the plate spring of FIG. 3;

FIG. 6 is an enlarged view around the plate spring of FIG. 4;

FIG. 7 is a perspective view of a blade driving device according to the second embodiment of the present disclosure;

FIG. 8 is an exploded perspective view of the blade driving device of FIG. 7; and

FIG. 9 is a diagram showing the plate spring of FIG. 8.

### DETAILED DESCRIPTION OF THE DRAWINGS

Hereinafter, embodiments of the present disclosure are explained with reference to drawings.

### First Embodiment

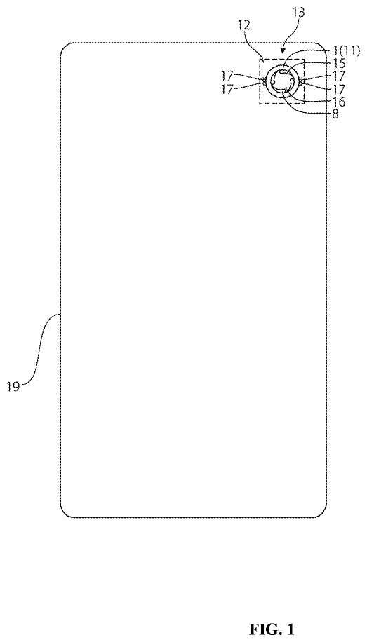

As shown in FIG. 1, a camera device 13 includes a blade driving device 11 according to the first embodiment of the present disclosure and a lens driving device 12, and is accommodated in a smartphone 19.

The camera device 13 includes: a lens body 15; an image sensor 16 that converts light from the lens body 15 into an electrical signal; a lens driving device 12 that drives the lens body 15; and a blade driving device 11 that drives the blades 8 arranged on the front side of the lens body 15.

Hereinafter, the direction in which the light from the subject is incident is appropriately referred to as a Z direction, one direction orthogonal to the Z direction is appropriately referred to as an X direction, and a direction orthogonal to both the Z direction and the X direction is appropriately referred to as a Y direction. Further, the +Z side of the optical axis of the lens body 15, which is the side of the subject, may be referred to as a front side, and the −Z side, which is the side on which the image sensor 16 on the opposite side of the subject is provided, may be referred to as a rear side.

The lens driving device 12 has a lens carrier that movably holds the lens body 15 in the optical axis direction. The blade driving device 11 is configured such that the optical axis of the lens body 15 becomes the central axis of the blade driving device 11. The central axis is an axis passing through the center of the blade driving device 11 in the Z direction, and the central axis direction and the Z direction are the same. The central axis direction may also be a front-rear direction. In the lens driving device 12, metallic receiving portions 17 are provided at ends on the −Y side and +Y side of the front surface of the lens carrier. The receiving portions 17 extend toward the +Z side. The lens driving device 12 supports metal members 70 protruding to −Y side and the +Y side of the blade driving device 11 by the receiving portions 17, and supplies electric power to the blade driving device 11 via the receiving portions 17 and the metal members 70.

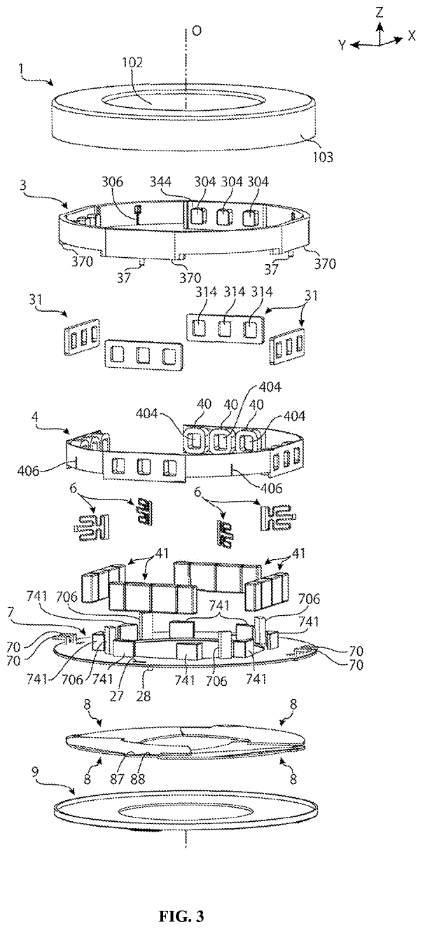

As shown in FIG. 3, the blade driving device 11 includes a cover 1, a movable ring 3, four yoke 31, an FPC 4, twelve coils 40, four plate springs 6, four magnets 41, a base 7, four blades 8, and a rear cover 9. Among these, the cover 1, the magnets 41, the base 7, and the rear cover 9 constitute a fixed portion which is not accompanied by movement with respect to the lens driving device 12.

The outer peripheral edge of the base 7 of an annular plate shape centered on the central axis O is fixed to the outer edge portion of the rear cover 9 of an annular plate shape. The outer edge portion of the rear cover 9 rises slightly, and four blades 8 are arranged in an annular gap between the base 7 and the rear cover 9.

The cover 1 has an inner peripheral wall portion 102 and an outer peripheral wall portion 103 extending rearward from a front side wall portion of an annular plate shape centered on the central axis O, and the inner peripheral wall portion 102 and outer peripheral wall portion 103 of the cover 1 are fixed to the inner peripheral edge and the outer peripheral edge of the base 7. The movable ring 3, the yokes 31, the FPC 4, the plate springs 6, and the magnets 41 are accommodated in an annular space surrounded by the cover 1 and the base 7.

Four metal members 70 are embedded in the base 7 so as to surround the through hole in the center of the base 7. One end portions of the four metal members 70 rise together with the column portions 706. The other end portions of two metal members 70 on the +Y side rise in a stepped shape at the outer edge on the +Y side of the base 7 and then project outward, and the other end portions of two metal members 70 on the −Y side rise in a stepped shape at the outer edge on the −Y side of the base 7 and then project outward. The portions of the four metal members 70 projecting to the +Y side and the −Y side are exposed to the outside from notches on the +Y side and the −Y side of the outer peripheral wall portion 103 of the cover 1, and the receiving portions 17 of the lens driving device 12 are welded or soldered to the rear sides of the exposed portions.

The column portions 706 rise from the +X+Y side, the +X−Y side, the −X+Y side, and the −X−Y side of the inner peripheral edge portion surrounding the through hole of the base 7. The column portion 706 has a rectangular parallelepiped shape and has side surfaces parallel to the central axis direction and the radial direction. Two table portions 741 are provided at intervals between the adjacent column portions 706 of the base 7. Magnets 41 are fixed to the outer surfaces of the table portions 741.

The movable ring 3 has an annular shape with a width in the central axis direction. The yokes 31 are fixed to grooves 344 on the +X side, the −X side, the +Y side, and the −Y side of the inner surface of the movable ring 3, and the FPC 4 is fixed to the inside thereof. Convex portions 304 of the movable ring 3 are fitted into the hole portions 314 of the yokes 31 and the hole portions 404 of the FPC 4. The three coils 40 are fixed to the +X side, the −X side, the +Y side, and the −Y side of the inner surface of the FPC 4, respectively. At this time, the convex portions 304 are fitted into the center holes of respective coils 40.

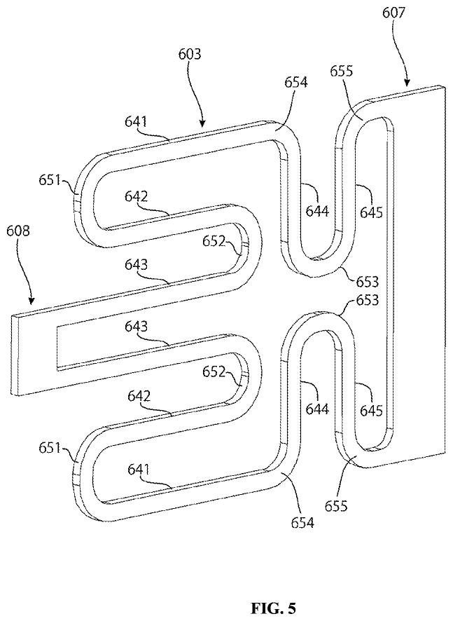

The movable ring 3, the yokes 31, the coils 40, and the FPC 4 are supported in a floating state from the fixed portion by the plate springs 6. As shown in FIG. 5, the plate spring 6 expands in the central axis direction and the radial direction, and has a plate-like inner edge portion 607, a plate-like outer edge portion 608, and an arm portion 603 elastically connecting the plate-like outer edge portion 608 and the plate-like outer edge portion 608. The inner edge portion 607 is longer than the outer edge portion 608 in the central axis direction, and the arm portion 603 is formed of two thread-like elastic members symmetrical in front and rear. Each of the elastic members on the front side and the rear side has three linear portions 641, 642, and 643 extending in the radial direction and aligned in the central axis direction, and two linear portions 644 and 645 extending in the central axis direction and aligned in the radial direction.

The arm portion 603 extending out from the front end and rear end of the inner edge portion 607 toward the outer peripheral side is bent toward the center in the front-rear direction in an arc shape and is connected to one ends of the linear portions 645. The arm portion 603 is connected to one ends of the linear portions 641 from the other ends of the linear portions 645 via the semicircular connecting portions 653, the linear portions 644, and the arc-shaped connecting portions 654. The arm portion 603 is further connected to one ends of the linear portions 643 from the other ends of the linear portions 641 via the semicircular connecting portions 651, the linear portions 642, and the semicircular connecting portions 652, and the other end portions of the linear portion 643 are connected to the front end and the rear end of the outer edge portion 608.

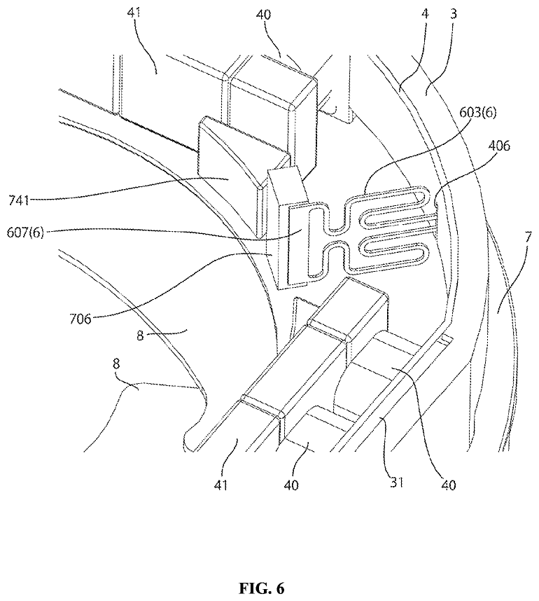

As shown in FIG. 6, the inner edge portion 607 of the plate spring 6 is fixed to the side surface of the column portion 706 parallel to the central axis direction and the radial direction. The plate spring 6 is passed through a slit 406 of the FPC 4 and fixed by inserting the outer edge portion 608 into a slit 306 provided in the movable ring 3 and extending in the central axis direction. The inner edge portion 607 of the plate spring 6 is electrically connected to one end portion of the metal members 70. The outer edge portion 608 of the plate spring 6 is electrically connected to the FPC 4 at the slit 406. The coil 40 is electrically connected to the FPC 4. Thus, the coil 40 is electrically connected to the metal members 70, that is, the plate spring 6 constitutes a part of the electric circuit.

The rear surface of the movable ring 3 is provided with movable pins 37 projecting backward, and the movable pins 37 project further backward through long holes 27 provided in the base 7 and extending in the tangential direction of the circumference, and are fitted into the movable holes 87 provided in the blades8. The movable hole 87 extends in a direction between the radial direction and the tangential direction of the circumference. The rear surface of the base 7 is provided with fixing pins 28 projecting backward, and the fixing pins 28 are fitted into fixing holes 88 provided in the blades 8. The movable hole 87 and the fixing hole 88 of the blade 8 are provided close to each other in the tangential direction of the circumference.

The magnets 41 and the three coils 40 on the +X side and the −X side face each other in parallel, and the magnets 41 and the three coils 40 on the +Y side and the −Y side face each other in parallel. When an electric current is supplied to the coils 40, a thrust force in a direction around the central axis O is produced by the electromagnetic force generated by the coils 40 and the magnets 41. The movable ring 3 rotates with respect to the base 7 by this thrust force. With this rotation, the movable pin 37 of the movable ring 3 moves in the long hole 27 of the base 7 and the movable hole 87 of the blade 8, and the blade 8 rotates around the axis of the fixing pin 28 fitted in the fixing hole 88. By the rotation of the four blades 8, the size of the aperture surrounded by the inner periphery of the four blades 8 is changed, and the amount of light from the subject to the image sensor 16 via the lens body 15 is controlled.

At this time, for example, when no electric current flows in the coil 40, the plate spring 6 extends in the radial direction. Since the movable ring 3 rotates when an electric current flows in the coils 40, the plate spring 6 is elastically deformed so that the outer edge portion 608 moves in the circumferential direction with respect to the inner edge portion 607. When the flowing of the electric current is stopped, the plate spring 6 tries to return its elastic deformation to the original state, so that the movable ring 3 also returns to the initial position. Further, since the movable ring 3 is pressed by the spring force, it is difficult to change the position of the movable ring 3 in a state where no electric current flows.

The details of the present first embodiment are explained above. The blade driving device 11 in the present first embodiment, in which a central axis O is defined, includes: blades 8; a base 7 formed in an annular shape centered on the central axis O; a movable ring 3 formed in an annular shape centered on the central axis O; a driving mechanism (coils 40 and magnets 41) that drives the blades 8 by rotating the movable ring 3 around the central axis O with respect the base 7; and a plurality of plate springs 6 that connect the base 7 and the movable ring 3 to rotatably support the movable ring 3 with respect to the base 7. The plurality of plate springs 6 are provided at equal intervals around the central axis O and expand in the radial direction of a circle centered on the central axis O and in the central axis direction. The free movement of the blade 8 is restricted by the plate spring 6. Thus, it is possible to provide a blade driving device 11 in which the blade 8 does not move freely even when the driving force of the blade 8 is not applied.

### Second Embodiment

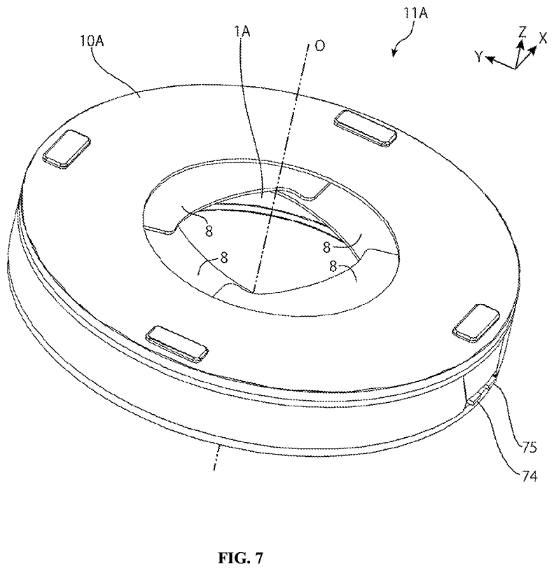

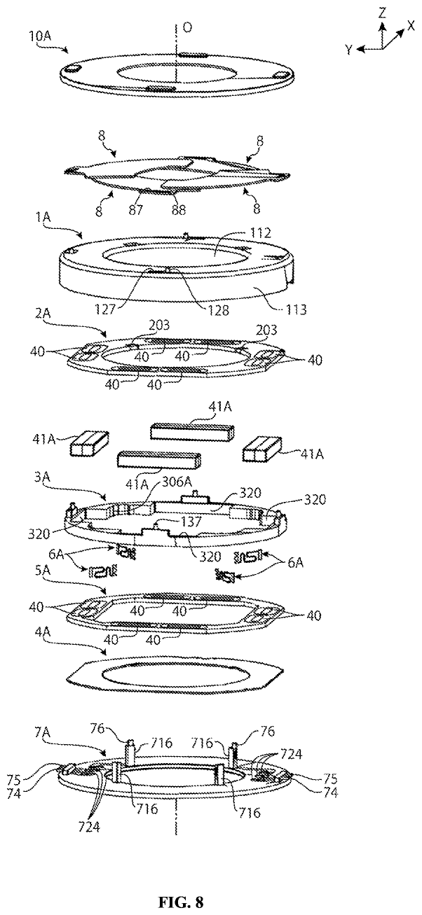

Next, the second embodiment of the present disclosure is described. As shown in FIG. 7 and FIG. 8, a blade driving device 11A according to the second embodiment is arranged between a front cover 10A and a cover 1A. In addition, a plate spring 6A has a shape in which only the rear half of the plate spring 6 of the first embodiment exists.

The blade driving device 11A includes a front cover 10A, four blades 8, a cover 1A, a front side coil substrate 2A, four magnets 41A, a movable ring 3A, four plate springs 6A, a rear side coil substrate 5A, a circuit board 4A, and a base 7A. Among these, the front cover 10A, the cover 1A, the front side coil substrate 2A, the rear side coil substrate 5A, the circuit board 4A, and the base 7A constitute a fixed portion which is not accompanied by movement with respect to the lens driving device 12.

The cover 1A has an inner peripheral wall portion 112 and an outer peripheral wall portion 113 extending rearward from a front side wall portion of an annular plate shape centered on the central axis O, the four blades 8 are arranged on the cover 1A, and the front cover 10A is arranged on the front side of the blades 8. The base 7A has an annular plate shape centered on the central axis O, and the rear edges of the inner peripheral wall portion 112 and the outer peripheral wall portion 113 of the cover 1A are fixed to the inner peripheral edge portion and the outer peripheral edge portion of the base 7A. The front side coil substrate 2A, the magnets 41A, the movable ring 3A, the rear side coil substrate 5A, and the circuit board 4A are accommodated in an annular space surrounded by the front cover 10A and the cover 1A. The column portions 706 rise from the +X+Y side, the +X−Y side, the −X+Y side, and the −X−Y side of the inner peripheral edge portion surrounding the through hole of the base 7A. The column portion 706 has a rectangular parallelepiped shape and has side surfaces parallel to the central axis direction and the radial direction.

Two metal members 74, two metal members 75, and two metal members 76 are embedded in the base 7A. One end portions of the respective metal members 74 and 75 are exposed to the front and rear in holes 724 of the base 7A, and the other end portions of the respective metal members 74 and 75 rise in a stepped shape at the outer edges on the +Y side and the −Y side of the base 7A and then project outward. The portions of the metal members 74 and 75 projecting to the +Y side and the −Y side are exposed to the outside from notches on the +Y side and the −Y side of the outer peripheral wall portion 113 of the cover 1A, and the receiving portions 17 of the lens driving device 12 are welded or soldered to the rear sides of the exposed portions.

One end portions of the respective metal members 76 are exposed to the front and rear in holes 724 of the base 7A. The respective metal members 76 extend to the column portions 716 erected on the +X+Y side and the +X−Y side of the inner peripheral edge portion of the base 7A, rise at the column portions 716, and extend forward along the column portions 716. The front end of the rising portion of each metal member 76 protrudes to the tip of the front edge of the column portion 716 and exposed, and this front end is electrically connected to the land 203 of the front side coil substrate 2A.

The front side coil substrate 2A is fixed to the rear surface of the front side wall portion of the cover 1A. The circuit board 4A is fixed to the front surface of the base 7A, and the rear side coil substrate 5A is fixed to the front surface of the circuit board 4A. The metal members 74, 75, and 76 are electrically connected to the lands (not shown) on the rear surface of the circuit board 4A at the portions exposed in the holes 724, respectively. In addition, the circuit board 4A and the rear side substrate 5A are also electrically connected. Thus, the circuit board 4A is electrically connected to the outside of the blade driving device 11A, and is also electrically connected to the front side coil substrate 2A and the rear side coil substrate 5A. Every two coils 40 are embedded in the front side coil substrate 2A and rear side coil substrate 5A on the +X side, the −X side, the +Y side, and the −Y side.

The movable ring 3A has an annular shape with a width in the central axis direction. Recess portions 320 are provided on the inner peripheral side surface on the +X side, the −X side, the +Y side, and the −Y side of the movable ring 3A, and the magnets 41A are fixed to the recess portions 320.

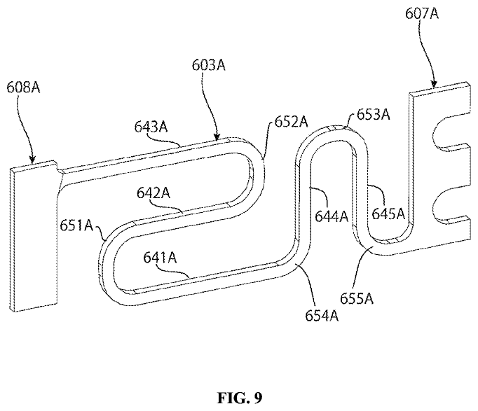

The movable ring 3A and the magnets 41A are supported by the plate springs 6A. As shown in FIG. 9, the plate spring 6A has an inner edge portion 607A, an outer edge portion 608A, and an arm portion 603A. The arm portion 603A of the plate spring 6A has the same shape as that of the rear half of the arm portion 603 of the plate spring 6 of the first embodiment. That is, the arm portion 603A has three linear portions 641A, 642A, 643A extending in the radial direction and aligned in the central axis direction, and two linear portions 644A, 645A extending in the central axis direction and aligned in the radial direction. Further, it has connecting portions 651A, 652A, 653A, 654A connecting the linear portions and a connecting portion 655A connecting the inner edge portion 607A and the linear portion 645A. The inner edge portion 607A of the plate spring 6A is fixed to the side surface of the column portion 716 of the base 7A parallel to the central axis direction and the radial direction. The outer edge portion 608A of the plate spring 6A is inserted into and fixed to the slit 306A of the movable ring 3A.

The movable ring 3A has movable pins 137 projecting forward from the front surface, the movable pins 137 are passed through long holes 127 extending in the tangential direction of the circumference provided in the cover 1A to project further forward, and the projecting portions are fitted into the movable holes 87 provided in the blades 8. The movable hole 87 extends in a direction between the radial direction and the tangential direction of the circumference. The front surface of the front side wall portion of the cover 1A is provided with fixing pins 128 projecting forward, and the fixing pins 128 are fitted into the fixing holes 88 provided in the blades 8. The movable hole 87 and the fixing hole 88 of the blade 8 are provided close to each other in the tangential direction of the circumference.

The coils 40 of the front side coil substrate 2A on the +X side, the −X side, the +Y side, and the −Y side face the front side plate surfaces of the magnets 41A, and the coils 40 of the rear side coil substrate 5A face the rear side plate surfaces of the magnets 41A. When an electric current is supplied to the coils 40 of the front side coil substrate 2A and the rear side coil substrate 5A, a thrust force in a direction around the central axis O is produced by the electromagnetic force generated by the coils 40 and the magnets 41A. The movable ring 3A rotates with respect to the base 7A by this thrust force. With this rotation, the movable pin 137 of the movable ring 3A moves in the long hole 127 of the base 7A and the movable hole 87 of the blade 8, and the blade 8 rotates around the axis O of the fixing pin 128 fitted in the fixing hole 88. By the rotation of the four blades 8, the size of the aperture surrounded by the inner periphery of the four blades 8 is changed, and the amount of light from the subject to the image sensor 16 via the lens body 15 is controlled.

At this time, for example, when no electric current flows in the coil 40, the plate spring 6A extends in the radial direction. Since the movable ring 3 rotates when an electric current flows in the coils 40, the plate spring 6A is elastically deformed in such a manner that the outer edge portion 608A moves in the circumferential direction with respect to the inner edge portion 607A. When the flowing of the electric current is stopped, the plate spring 6A tries to return its elastic deformation to the original state, so that the movable ring 3A also returns to the initial position. Further, since the movable ring 3A is pressed by the spring force, it is difficult to change the position of the movable ring 3A in a state where no electric current flows.

The details of the present second embodiment are explained above. The blade driving device 11A in the present second embodiment, in which a central axis O is defined, includes: blades 8; a base 7A formed in an annular shape centered on the central axis O; a movable ring 3A formed in an annular shape centered on the central axis O; a driving mechanism (coils 40 and magnets 41A) that drives the blades 8 by rotating the movable ring 3A around the central axis O with respect the base 7A; and a plurality of plate springs 6A that connect the base 7A and the movable ring 3A to rotatably support the movable ring 3A with respect to the base 7A. The plurality of plate springs 6A are provided at equal intervals around the central axis O and expand in the radial direction of a circle centered on the central axis O and in the central axis direction. The free movement of the blade 8 is restricted by the plate spring 6A. Thus, it is possible to provide a blade driving device 11A in which the blade 8 does not move freely even when the driving force of the blade 8 is not applied. Thus, the same effect as the above-mentioned first embodiment can also be obtained according to the present second embodiment.

It is to be noted that, four plate springs 6, 6A were used in the above embodiments, but if they are arranged at equal intervals, the number may be two, three, or more than four. In addition, the arm portions 603, 603A were configured by combining three linear portions extending in the radial direction and two linear portions extending in the central axis direction, but other numbers may be used. In addition, a linear portion extending in the direction between the radial direction and the central axis direction may be used.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A blade driving device in which a central axis is defined, comprising:
a blade;
a base formed in an annular shape centered on the central axis;
a movable ring formed in an annular shape centered on the central axis;
a driving mechanism that drives the blade by rotating the movable ring around the central axis with respect to the base; and
a plurality of plate springs that connect the base and the movable ring to rotatably support the movable ring with respect to the base, wherein the plurality of plate springs are arranged at equal intervals around the central axis and expand in a radial direction of a circle centered on the central axis and in a central axis direction.

2. The blade driving device according to claim 1, wherein a column portion is erected on an inner peripheral edge portion of the base, an inner edge portion of the plate spring is fixed to a side surface of the column portion.

3. The blade driving device according to claim 1, wherein the side surface of the column portion is parallel to the central axis direction and the radial direction.

4. The blade driving device according to claim 1, wherein a slit is formed in the movable ring from an inside, and an outer edge portion of the plate spring is fixed to the slit.

5. The blade driving device according to claim 1, wherein the plate spring comprises an arm portion configured by a thread-like elastic member, a plurality of linear portions extending in the radial direction and aligned in the central axis direction, and a connecting portion that connects two adjacent linear portions in an arc shape.

6. The blade driving device according to claim 1, wherein the plate spring comprises an arm portion configured by a thread-like elastic member, a plurality of linear portions extending in the central axis direction and aligned in the radial direction, and a connecting portion that connects two adjacent linear portions in an arc shape.

7. The blade driving device according to claim 1, wherein the driving mechanism comprises a coil attached to the movable ring, and the plate spring constitutes a portion of an electric circuit connecting the base and the coil.

8. A camera device comprising the blade driving device according to claim 1.

9. An electronic apparatus comprising the camera device according to claim 8.
